(19) United States
(12) Patent Application Publication
(10) Pub. No.: US 2025/0126519 A1
(43) Pub. Date: Apr. 17, 2025

(54) COMPUTATION OFFLOADING METHOD AND APPARATUS, ELECTRONIC DEVICE, AND STORAGE MEDIUM

(71) Applicant: Luxshare Precision Industry Company Limited, Shenzhen (CN)

(72) Inventor: GUANHSIUNG WANG, SHENZHEN (CN)

(73) Assignee: Luxshare Precision Industry Company Limited, Shenzhen (CN)

(21) Appl. No.: 18/649,098

(22) Filed: Apr. 29, 2024

(30) Foreign Application Priority Data
Oct. 16, 2023 (CN) 202311343453.X

(51) Int. Cl. H04W 28/08; H04W 28/02; H04W 28/18

(52) U.S. Cl. CPC H04W 28/08; H04W 28/0236; H04W 28/18

(57) ABSTRACT

A computation offloading method is applied to the first node and includes acquiring offloading requirement information sent by a second node; determining the current computational capacity of the first node according to the offloading requirement information; when the current computational capacity of the first node satisfies an offloading requirement, sending offloading acceptance information to the second node so that the second node performs computation offloading.

### CROSS-REFERENCE TO RELATED APPLICATION(S)

This application claims priority to Chinese Patent Application No. 202311343453.X filed Oct. 16, 2023, the disclosure of which is incorporated herein by reference in its entirety.

### TECHNICAL FIELD

The present disclosure relates to the field of communication technology, in particular, a computation offloading method and apparatus, an electronic device, and a storage medium.

### BACKGROUND

With the technological development of the Internet of Things, 5G heterogeneous networks, edge computing, and cloud computing, many client data operations and storage are applied to cloud servers. However, since the geographical location of a cloud server is usually far from the client, data transmission delay may occur.

During the computation offloading process, when the client cannot complete the operation by itself, the client may typically request assistance from the cloud server. However, with an increasing number of client apparatuses, transmitting data to the cloud may result in insufficient bandwidth. Moreover, since the client is far away from the cloud server at the network layer, security and privacy are at risk. In contrast, if functions such as storage, processing, and analysis of such data are moved from the cloud to edge apparatuses/servers close to the client, the instruction cycle can be increased, the delay can be reduced, and meanwhile, reliability, security, and privacy can be improved. Therefore, assisting the client in computation offloading is currently an urgent problem to be solved.

### SUMMARY

The present disclosure provides a computation offloading method and apparatus, an electronic device, and a storage medium to assist a second node in performing computation offloading via a first node and improve the reliability of computation offloading.

According to an aspect of the present disclosure, a computation offloading method is provided. The method is applied to a first node and includes acquiring offloading requirement information sent by a second node; determining the current computational capacity of the first node according to the offloading requirement information; when the current computational capacity of the first node satisfies an offloading requirement, sending offloading acceptance information to the second node so that the second node performs computation offloading.

According to another aspect of the present disclosure, a computation offloading method is provided. The method is applied to a second node and includes sending offloading requirement information to a first node; receiving offloading acceptance information sent by the first node, and when it is approved that the first node assists in offloading, sending operation information to the first node.

According to another aspect of the present disclosure, a computation offloading apparatus is provided. The apparatus is applied to a first node and includes an information acquisition module, a capacity determination module, and an operation offloading module.

The information acquisition module is configured to acquire offloading requirement information sent by a second node.

The capacity determination module is configured to determine the current computational capacity of the first node according to the offloading requirement information.

The operation offloading module is configured to send offloading acceptance information to the second node when the current computational capacity of the first node satisfies an offloading requirement so that the second node performs computation offloading.

According to another aspect of the present disclosure, a computation offloading apparatus is provided. The apparatus is applied to a second node and includes a first information sending module and a second information sending module.

The first information sending module is configured to send offloading requirement information to a first node.

The second information sending module is configured to receive offloading acceptance information sent by the first node, and when it is approved that the first node assists in offloading, send operation information to the first node.

According to another aspect of the present disclosure, an electronic device is provided. The electronic device includes at least one processor and a memory. The memory is in communication with the at least one processor.

The memory stores a computer program executable by the at least one processor. The computer program is configured to be executed by the at least one processor to cause the at least one processor to execute the computation offloading method described in any embodiment of the present disclosure.

According to another aspect of the present disclosure, a computer-readable storage medium is provided, which is configured to store computer instructions. The computer instructions are configured to be executed by a processor to implement the computation offloading method described in any embodiment of the present disclosure.

### BRIEF DESCRIPTION OF DRAWINGS

To illustrate technical solutions in embodiments of the present disclosure more clearly, accompanying drawings used in the description of the embodiments are briefly described below. Apparently, the accompanying drawings described below illustrate part of embodiments of the present disclosure, and those of ordinary skill in the art may acquire other accompanying drawings based on the accompanying drawings described below on the premise that no creative work is done.

FIG. 1 is a flowchart illustrating a computation offloading method according to embodiment one of the present disclosure.

FIG. 2 is a flowchart illustrating a computation offloading method according to embodiment two of the present disclosure.

FIG. 3 is a flowchart illustrating a computation offloading method according to embodiment three of the present disclosure.

FIG. 4 is a flowchart illustrating a computation offloading method according to embodiment three of the present disclosure.

FIG. 5 is a diagram illustrating the system environment architecture of a computation offloading according to embodiment four of the present disclosure.

FIG. 6 is a flowchart illustrating a computation offloading method according to embodiment four of the present disclosure.

FIG. 7 is a diagram illustrating the structure of a computation offloading apparatus according to embodiment five of the present disclosure.

FIG. 8 is a diagram illustrating the structure of a computation offloading apparatus according to embodiment six of the present disclosure.

FIG. 9 is a diagram illustrating the structure of an electronic device implementing a computation offloading method according to an embodiment of the present disclosure.

### DETAILED DESCRIPTION

The solutions in embodiments of the present disclosure are described clearly and completely in conjunction with drawings in the embodiments of the present disclosure from which the solutions are better understood by those skilled in the art. Apparently, the embodiments described below are part, not all, of the embodiments of the present disclosure. Based on the embodiments described herein, all other embodiments acquired by those skilled in the art on the premise that no creative work is done are within the scope of the present disclosure.

It is to be noted that terms such as “first” and “second” in the description, claims, and drawings of the present disclosure are used to distinguish between similar objects and are not necessarily used to describe a particular order or sequence. It should be understood that the data used in this manner are interchangeable where appropriate so that the embodiments of the present disclosure described herein may also be implemented in a sequence not illustrated or described herein. Additionally, terms “comprising”, “including”, and any other variations thereof are intended to encompass a non-exclusive inclusion. For example, a process, method, system, product, or device that includes a series of steps or units not only includes the expressly listed steps or units but may also include other steps or units that are not expressly listed or are inherent to such a process, method, product, or device.

### Embodiment One

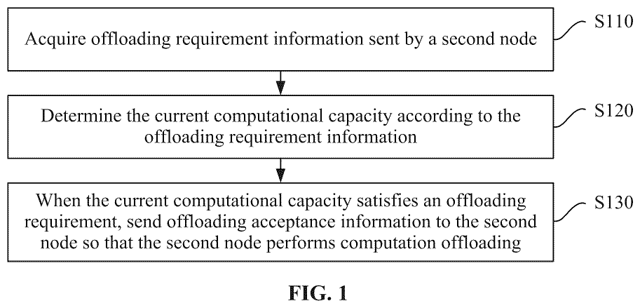

FIG. 1 is a flowchart of a computation offloading method according to embodiment one of the present disclosure. This embodiment may be applied to a situation where a first node assists a second node in performing computation offloading. The method may be executed by a computation offloading apparatus. The computation offloading apparatus may be implemented in the form of software and/or hardware and may be configured in the first node. As shown in FIG. 1, the method includes the steps described below.

In S110, offloading requirement information sent by a second node is acquired.

The second node refers to a node on which computation offloading is to be performed. The second node may be a node that provides local services to clients and is the other party receiving services. In practical operation, the second node may include but is not limited to, a client. At least one second node may be provided. Each second node may work independently.

The first node may refer to a node that assists the second node in performing computation offloading. The first node may include but is not limited to, devices that provide an entry point to an enterprise or service provider core, such as computers, routers, switches, integrated access devices (IADs), other similar side devices, or edge servers. The number of first nodes may not be limited. At least one first node may be provided. Each first node may work independently. In an embodiment, the first node may include a multiple access edge computing system.

The offloading requirement information may refer to an offloading requirement of the second node. When the computational capacity of the first node satisfies the offloading requirement information, the first node may assist the second node in performing computation offloading. Illustratively, the offloading requirement information may include but is not limited to, the maximum allowable delay time, the power of the second node, the amount of data to be calculated, and computing complexity. In an embodiment, the offloading requirement information may be a data packet or a packaged file, which is not limited thereto.

In this embodiment of the present disclosure, when the second node sends the offloading requirement information, the first node may receive the offloading requirement information sent by the second node. In practical operation, the first node may receive the offloading requirement information sent by the second node in real time; alternatively, threshold time may be configured, and the offloading requirement information may be acquired every threshold time.

In S120, the current computational capacity is determined according to the offloading requirement information.

The current computational capacity may refer to the current computational capacity of the first node. The current computational capacity may be determined according to the offloading requirement information. The current computational capacity may include the following: The offloading requirement is satisfied; the offloading requirement is not satisfied. In practical operation, the current computational capacity may be judged by multiple parameters. Illustratively, the current computational capacity of the first node may be determined according to the current remaining computational capacity, the maximum delay time, and the wireless communication quality information.

In an embodiment of the present disclosure, after receiving the offloading requirement information sent by the second node, the first node may parse the offloading requirement information and determine the current computational capacity according to the offloading requirement information. In practical operation, it may be determined according to the offloading requirement information whether the current remaining computational capacity, the maximum delay time, and the wireless communication quality information satisfy a preset condition, and then it may be determined whether the current computational capacity satisfies the offloading requirement.

In an embodiment, a computational capacity requirement may be determined according to the amount of data to be calculated and the computing complexity in the offloading requirement information; the total availability rate of the central processing unit minus the current utilization rate and the necessary utilization rate is used as the remaining utilization rate, and the product of the remaining utilization rate and the total computational capacity is used as the current remaining computational capacity. When the current remaining computational capacity is greater than or equal to the computational capacity requirement, it is determined that the current remaining computational capacity satisfies the preset condition; when the current remaining computational capacity is less than the computational capacity requirement, it is determined that the current remaining computational capacity does not satisfy the preset condition.

The uplink transmission rate at which the second node uploads the offloading requirement information is extracted; the data transmission time is determined according to the uplink transmission rate and the amount of data to be calculated in the offloading requirement information; the data operation time is determined according to the amount of data to be calculated and the current remaining computational capacity; and the sum of the data transmission time and the data operation time is used as the maximum delay time. When the maximum delay time is less than or equal to the maximum allowable delay time in the offloading requirement information, it is determined that the maximum delay time satisfies the preset condition; when the maximum delay time is greater than the maximum allowable delay time, it is determined that the maximum delay time does not satisfy the preset condition.

The received signal strength of the offloading requirement information uploaded by the second node may be extracted. When the received signal strength is greater than or equal to the preset received signal strength threshold, it is determined that the communication quality requirement satisfies the preset condition; when the received signal strength is less than the preset received signal strength threshold, it is determined that the communication quality requirement does not satisfy the preset condition. When the current remaining computational capacity, the maximum delay time, and the wireless communication quality information all satisfy the preset condition, it is determined that the computational capacity of the current multiple access edge computing system satisfies the offloading requirement. When any one of the current remaining computational capacity, the maximum delay time, or the wireless communication quality information does not satisfy the preset condition, it is determined that the computational capacity of the current multiple access edge computing system does not satisfy the offloading requirement.

In S130, when the current computational capacity satisfies an offloading requirement, offloading acceptance information is sent to the second node so that the second node performs computation offloading.

The offloading acceptance information is information indicating whether the second node receives offloading assistance. When the second node accepts offloading assistance, the first node may assist the second node in performing computation offloading. In an embodiment, when the second node does not accept the offloading acceptance information, the offloading assistance of the first node may be rejected.

In an embodiment of the present disclosure, when the current computational capacity satisfies the offloading requirement, the first node may send the offloading acceptance information to the second node and wait for feedback from the second node. When the second node approves the offloading acceptance information, the first node may assist the second node in performing the computation offloading.

In an embodiment, when approving the offloading acceptance information, the second node may send operation information to the first node, and the first node may assist the second node in performing computation offloading according to the operation information.

According to the embodiments of the present disclosure, offloading requirement information sent by a second node is acquired, the current computational capacity is determined according to the offloading requirement information, and when the current computational capacity satisfies an offloading requirement, offloading acceptance information is sent to the second node so that the second node performs computation offloading. In this manner, when the computational capacity of the first node satisfies the offloading requirement, the first node can assist the second node in performing computation offloading, and when the second node cannot complete the operation on its own and requests the cloud server to assist in the operation, the computing pressure on the cloud server is reduced. Meanwhile, the security risks of the second node transmitting data to the cloud server are reduced, the security of data transmission in the process of computation offloading is improved, and user experience is enhanced.

In an embodiment, a computation offloading method also includes the steps described below.

When the current computational capacity does not satisfy the offloading requirement, it is determined whether another first node satisfying the offloading requirement exists within the threshold range.

If the another first node exists, offloading request information of the second node is forwarded to the another first node, and offloading change information is sent to the second node so that the another first node assists the second node in performing computation offloading.

If the another first node does not exist, offloading rejection information is fed back to the second node, and assistance for the second node in performing computation offloading is refused.

The threshold range may be a distance range configured by a user as required or a distance range configured according to the signal range. The offloading request information refers to information that the current first node requests another first node whose current computational capacity satisfies the offloading requirement to assist the second node in performing computation offloading. When the another first node satisfying the offloading requirement receives the offloading request information, the another first node may assist the second node in performing computation offloading.

The offloading change information refers to information sent by the first node to the second node to request the second node to change to request another first node that satisfies the offloading requirement to assist in performing computation offloading. The second node may send the operation information to the another first node satisfying the current offloading requirement after receiving the offloading change information. The offloading rejection information refers to a rejection assistance instruction sent by the first node to the second node.

In an embodiment of the present disclosure, when the current computational capacity does not satisfy the offloading requirement, the current computational capacity of another first node within the threshold range may be acquired, and when the another first node satisfying the offloading requirement within the threshold range is received, the offloading request information of the second node may be forwarded to the another first node so that the another first node assists the second node in performing computation offloading. Meanwhile, the first node may send the offloading change information to the second node to inform the second node that the current computational capacity does not satisfy the offloading requirement and another first node replacing the first node assists in offloading. When another first node satisfying the offloading requirement does not exist within the threshold range, the first node may send offloading rejection information to the second node and refuse to assist the second node in offloading. Thus, it is ensured that when the current computational capacity of the first node does not satisfy the offloading requirement, another first node satisfying the offloading requirement is searched promptly, and the second node can be assisted in offloading to a greater extent.

In an embodiment, before determining the current computational capacity according to the offloading requirement information, the method also includes the steps described below.

An encrypted information identifier sent by the second node is received. The encrypted information identifier includes a first encrypted information identifier and a second encrypted information identifier. The first encrypted information identifier is determined by the XOR operation of the identity document of the second node and the International Mobile Equipment Identity of the second node. The second encrypted information identifier is the user information corresponding to the identity document of the second node.

The first encrypted information identifier is sent to a cloud server, and a third encrypted information identifier fed back by the cloud server is received. The third encrypted information identifier includes a first node group identifier and a fourth encrypted information identifier corresponding to the second encrypted information identifier. The fourth encrypted information identifier is the user information queried by the cloud server according to the first encrypted information.

When the second encrypted information identifier is identical to the fourth encrypted information identifier, it is determined that the identity of the second node is a legal node.

The encrypted information identifier may be an identifier representing the identity of the second node and sent by the second node. The encrypted information identifier may include a first encrypted information identifier and a second encrypted information identifier. The first encrypted information is the XOR operation of the identity document (ID) of the second node and the International Mobile Equipment Identity of the second node. The second encrypted information may be the user information corresponding to the identity document of the second node. The first node group identifier may refer to an identifier of a group to which the first node belongs. The first node may have multiple groups, and each group has a corresponding Group_ID (the first node group ID).

The identity document is an identifier representing the identity of the second node. Identity documents corresponding to different second nodes are different. The user information may be information corresponding to the user according to the identity document of the second node. The fourth encrypted information identifier is the user information queried by the cloud server according to the first encrypted information.

In an embodiment of the present disclosure, upon receiving the encrypted information identifier of the second node, the first node may disassemble the encrypted information identifier into a first encrypted information identifier and a second encrypted information identifier. The first node may send the disassembled first encrypted information identifier to the cloud server. The cloud server searches for a fourth encrypted information identifier according to the first encrypted information identifier and combines the first node group identifier and the fourth encrypted information identifier into a third encrypted information identifier. The first node may receive the third encrypted information identifier according to the first node group identifier and extract the fourth encrypted information identifier in the third encrypted information identifier. When the second encrypted information identifier is identical to the fourth encrypted information identifier, it is determined that the identity of the second node is a legal node. In an embodiment, when the first node sends the first encrypted information identifier to the cloud server, an encryption key may be accompanied to increase the security of information transmission.

### Embodiment Two

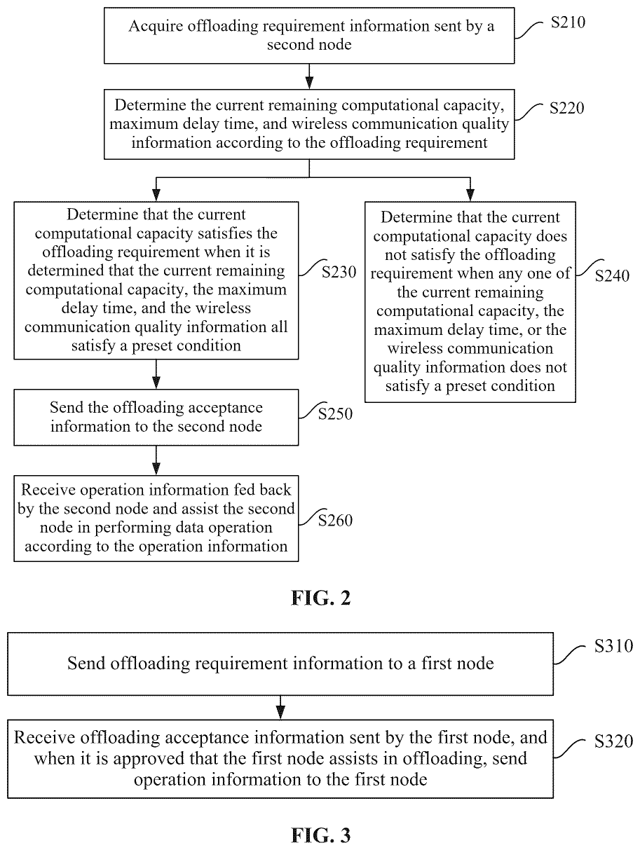

FIG. 2 is a flowchart of a computation offloading method according to embodiment two of the present disclosure. This method is further optimized and expanded based on the preceding embodiments and may be combined with various optional technical solutions in the preceding embodiments. As shown in FIG. 2, the method includes the steps described below.

In S210, offloading requirement information sent by a second node is acquired.

In S220, the current remaining computational capacity, maximum delay time, and wireless communication quality information are determined according to the offloading requirement.

The current remaining computational capacity may refer to the computational capacity of the current first node for processing operations. In practical operations, it is possible to determine the remaining utilization rate of the central processing unit, and the product of the remaining utilization rate and the total computational capacity is used as the current remaining computational capacity.

The maximum delay time may be the delay time for the first node to assist the second node. In an embodiment, the maximum delay time may include the sum of the data transmission time and the data operation time. The wireless communication quality information may be the degree of effectiveness of the communication in satisfying the user's communication needs. In practical operation, the wireless communication quality information may be determined according to the received signal strength of the offloading requirement information uploaded by the second node.

In an embodiment, determining the current remaining computational capacity, the maximum delay time, and the wireless communication quality information according to the offloading requirement includes: using the product of the remaining utilization rate of the central processing unit and the total computational capacity as the current remaining computational capacity; extracting the uplink transmission rate at which the second node uploads the offloading requirement information, and using the product of the reciprocal of the uplink transmission rate and an amount of data to be calculated in the offloading requirement information as data transmission time; using the ratio of the amount of data to be calculated to the current remaining computational capacity as data operation time; using the sum of the data transmission time and the data operation time as the maximum delay time; extracting received signal strength of the offloading requirement information uploaded by the second node as the wireless communication quality information.

The remaining utilization rate may refer to the proportion of the currently available computational capacity of the central processing unit to the total computational capacity and may be the total computational capacity minus the current utilization rate and the necessary utilization rate. The uplink transmission rate may refer to the rate at which the second node uploads data to the first node and refers to the amount of data transmitted per unit of time. The amount of data to be calculated may refer to the total amount of data computation-offloaded by the second node. The received signal strength of uploading the offloading requirement information may be a received signal strength indication (RSSI).

In an embodiment of the present disclosure, it is possible to determine the remaining utilization rate of the central processing unit and the total computational capacity, and the product of the remaining utilization rate and the total computational capacity is determined as the current remaining computational capacity. The uplink transmission rate at which the second node uploads the offloading requirement information is extracted, the amount of data to be calculated in the offloading requirement information is extracted, and the product of the reciprocal of the uplink transmission rate and the amount of data to be calculated is used as the data transmission time. The ratio of the amount of data to be calculated to the current remaining computational capacity is used as the data operation time, and the sum of the data transmission time and the data operation time is used as the maximum delay time. The RSSI of the offloading requirement information uploaded by the second node is extracted and used as the wireless communication quality information.

In S230, it is determined that the current computational capacity satisfies the offloading requirement when it is determined that the current remaining computational capacity, the maximum delay time, and the wireless communication quality information all satisfy a preset condition.

In an embodiment, the preset condition includes at least one of the following: a computational capacity requirement, the maximum allowable delay time in the offloading requirement information, or a preset received signal strength threshold.

The computational capacity requirement is determined according to the amount of data to be calculated and the computing complexity in the offloading requirement information.

The maximum allowable delay time may be the maximum allowable computation offloading delay time of the second node. The preset received signal strength threshold may be configured in advance according to the user's needs. In an embodiment, the preset received signal strength threshold may include but is not limited to, −60 dBm, −65 dBm, and −70 dBm.

In an embodiment of the present disclosure, the maximum allowable delay time and the preset received signal strength threshold in the computational capacity requirement and offloading requirement information may be extracted. When the current remaining computational capacity is greater than or equal to the computational capacity requirement, it may be determined that the current remaining computational capacity satisfies the preset condition. When the maximum delay time is less than or equal to the maximum allowable delay time, it is determined that the maximum delay time satisfies the preset condition. When the wireless communication quality information is greater than or equal to the preset received signal strength threshold, it may be determined that the wireless communication quality information satisfies the preset condition. It is determined that the current computational capacity satisfies the offloading requirement when it is determined that the current remaining computational capacity, the maximum delay time, and the wireless communication quality information all satisfy the preset condition.

In S240, it is determined that the current computational capacity does not satisfy the offloading requirement when any one of the current remaining computational capacity, the maximum delay time, or the wireless communication quality information does not satisfy a preset condition.

In an embodiment, the maximum allowable delay time and the preset received signal strength threshold in the computational capacity requirement and offloading requirement information may be extracted. If the current remaining computational capacity is less than the computational capacity requirement, it may be determined that the current remaining computational capacity does not satisfy the preset condition. When the maximum delay time is greater than the maximum allowable delay time, it is determined that the maximum delay time does not satisfy the preset condition. When the wireless communication quality information is less than the preset received signal strength threshold, it may be determined that the wireless communication quality information satisfies the preset condition. It is determined that the current computational capacity does not satisfy the offloading requirement when it is determined that any of the current remaining computational capacity, the maximum delay time, or the wireless communication quality information does not satisfy the preset condition.

In S250, the offloading acceptance information is sent to the second node.

In an embodiment of the present disclosure, when the current computational capacity satisfies the offloading requirement, the offloading acceptance information is sent to the second node.

In S260, operation information fed back by the second node is received, and the second node is assisted in performing data operation according to the operation information.

The operation information may be data information that needs to be offloaded by the second node.

In an embodiment of the present disclosure, after accepting the offloading acceptance information, the second node may send the operation information to the first node, and the first node may assist the second node in performing the data operation according to the operation information.

In an embodiment of the present disclosure, offloading requirement information sent by a second node is acquired; the current remaining computational capacity, maximum delay time, and wireless communication quality information are determined according to the offloading requirement; it is determined that the current computational capacity satisfies the offloading requirement when it is determined that the current remaining computational capacity, the maximum delay time, and the wireless communication quality information all satisfy a preset condition; it is determined that the current computational capacity does not satisfy the offloading requirement when any one of the current remaining computational capacity, the maximum delay time, or the wireless communication quality information does not satisfy a preset condition; the offloading acceptance information is sent to the second node, the operation information fed back by the second node is received, and the second node is assisted in data operation according to the operation information. In this manner, the current computational capacity is determined according to whether the remaining computational capacity, the maximum delay time, and the wireless communication quality information exceed the preset condition, and the credibility of the current computational capacity is improved. Moreover, when the current computational capacity satisfies the offloading requirement, the operation information of the second node is acquired to prevent redundant transmission of operation information and improve the user experience.

In an embodiment, after sending the offloading acceptance information to the second node, the method also includes sending encryption request information to the second node so that the second node encrypts operation information according to the encryption request information.

The encryption request information may be a request instructing the second node to encrypt the operation information.

In an embodiment of the present disclosure, the first node may send the encryption request information to the second node. After receiving the encryption request, the second node may choose to accept or not accept the encryption request as required. When accepting the encryption request information, the second node may perform attribute encryption on the operation information according to the encryption request information, thereby ensuring the security of the operation information.

In an embodiment, after determining that the wireless communication quality information does not satisfy the preset condition, the method also includes sending switching wireless channel information to the second node so that the second node switches a wireless channel to send the offloading requirement information.

The switching wireless channel information may be an instruction from the first node to instruct the second node to change the wireless channel to send the offloading requirement information.

In an embodiment of the present disclosure, at least one information transmission wireless channel between the first node and the second node may be provided. When it is determined that the wireless communication quality information does not satisfy the preset condition, the first node may send the switching wireless channel information to the second node so that the second node switches the wireless channel to send the offloading requirement information. Thus, it is ensured that the communication quality of the first node satisfies the preset condition and then satisfies the offloading requirement.

In an embodiment, after the current computational capacity satisfies the offloading requirement, the method also includes the steps described below.

It is determined whether a requirement for the maximum delay time exists in the offloading requirement information.

If the requirement for the maximum delay time exists in the offloading requirement information, the operation information sent by the second node is acquired for offloading.

If the requirement for the maximum delay time does not exist in the offloading requirement information, the power of the second node is extracted in the offloading requirement information.

When the power of the second node is sufficient, it is determined that the second node satisfies a self-operation requirement, offloading rejection information is fed back to the second node, and assistance for the second node in performing computation offloading is refused.

When the power of the second node is insufficient, it is determined that the second node does not satisfy the self-operation requirement, the offloading request information is sent to another first node whose current computational capacity satisfies the offloading requirement, and offloading change information is sent to the second node so that the another first node assists the second node in the offloading.

The power of the second node may refer to whether the power of the second node satisfies a self-operation requirement. When the power of the second node satisfies the self-operation requirement, it may be considered that the power of the second node is sufficient. When the power of the second node does not satisfy the self-operation requirement, it may be considered that the power of the second node is insufficient.

In an embodiment of the present disclosure, the maximum delay time in the offloading requirement information may be extracted to determine whether a requirement exists for the maximum delay time. When a requirement exists for the maximum delay time, the first node may acquire the operation information sent by the second node for offloading. When a requirement does not exist for the maximum delay time, the power of the second node in the offloading requirement information may be extracted to determine whether the power of the second node is sufficient. When the power of the second node is sufficient, it may be considered that the second node satisfies a self-operation requirement, and the first node may send the offloading rejection information to the second node to refuse to assist the second node in offloading. When the power of the second node is insufficient, it may be considered that the second node does not satisfy the self-operation requirement, and the offloading request information may be sent to another first node whose current computational capacity satisfies the offloading requirement so that the another first node assists the second node in performing the computation offloading. Meanwhile, the first node may send offloading change information to the second node to inform the second node that the another first node assists the second node in offloading. In this manner, when the maximum delay time is not required and the power of the second node is sufficient, the second node performs self-operation, which saves the computational capacity of the first node to better serve the second node that requires the maximum delay time.

### Embodiment Three

FIG. 3 is a flowchart of a computation offloading method according to embodiment three of the present disclosure. This embodiment may be applied to a situation where a first node assists a second node in performing computation offloading. The method may be executed by a computation offloading apparatus. The computation offloading apparatus may be implemented in the form of software and/or hardware and may be configured in the second node. As shown in FIG. 3, the method includes the steps described below.

In S310, offloading requirement information is sent to a first node.

The offloading requirement information may include but is not limited to, the maximum allowable delay time, the power of the second node, the amount of data to be calculated, and computing complexity.

In an embodiment of the present disclosure, the second node may send the offloading requirement information to the first node simultaneously; alternatively, each piece of information in the offloading requirement information may be separately sent to the first node.

In S320, offloading acceptance information sent by the first node is received, and when it is approved that the first node assists in offloading, operation information is sent to the first node.

In an embodiment of the present disclosure, when the current computational capacity of the first node satisfies the offloading requirement, the first node may send the offloading acceptance information to the second node, and the second node may receive the offloading acceptance information sent by the first node. When approving that the first node assists in offloading, the second node may send the operation information to the first node.

In this embodiment of the present disclosure, the offloading acceptance information sent by the first node is received by the sending of the offloading requirement information to the first node. When it is approved that the first node assists in offloading, the operation information is sent to the first node to ensure that the first node can assist in offloading according to the information sent by the second node.

In an embodiment, a computation offloading method also includes the steps described below.

When it is disapproved that the first node assists in the offloading, rejection information is fed back to the first node, and the offloading requirement information is sent to another first node or self-offloading is performed.

In an embodiment of the present disclosure, when the offloading acceptance information sent by the first node is received, the rejection information may be fed back to the first node when it is disapproved that the first node assists in the offloading. Meanwhile, the offloading requirement information may be sent to another first node, or computation offloading is self-performed according to the operation information.

In an embodiment, a computation offloading method also includes sending an encrypted information identifier to the first node so that the first node verifies the identity according to the encrypted information identifier.

In an embodiment of the present disclosure, the second node may send an encrypted information identifier to the first node so that the first node verifies the identity according to the encrypted information identifier.

In an embodiment, a computation offloading method also includes the steps described below.

When encryption request information fed back by the first node is received, it is determined whether to approve attribute encryption of the operation information.

If the attribute encryption of the operation information is approved, the operation information is encrypted according to the encryption request information, and the encrypted operation information is fed back to the first node.

If the attribute encryption of the operation information is disapproved, self-offloading is performed according to the operation information.

In an embodiment of the present disclosure, when receiving the encryption request information fed back by the first node, the second node may determine whether to approve that the first node performs attribute encryption on the operation information. If it is approved that the first node performs attribute encryption on the operation information, the operation information may be encrypted according to the encryption request information, and the encrypted operation information is fed back to the first node so that the first node assists in offloading according to the operation information. If disapproving that the first node performs attribute encryption on the operation information, the second node may perform self-offloading according to the operation information.

### Embodiment Four

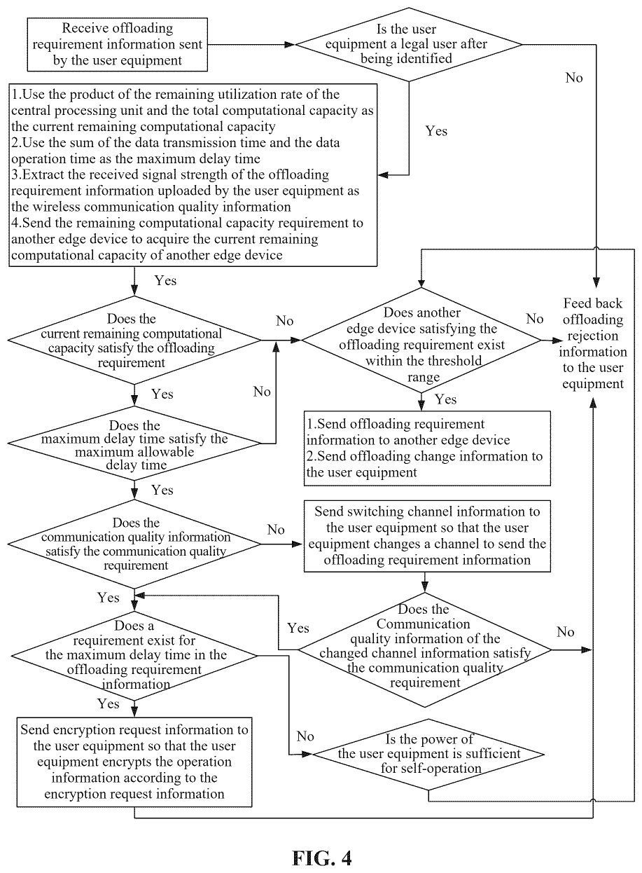

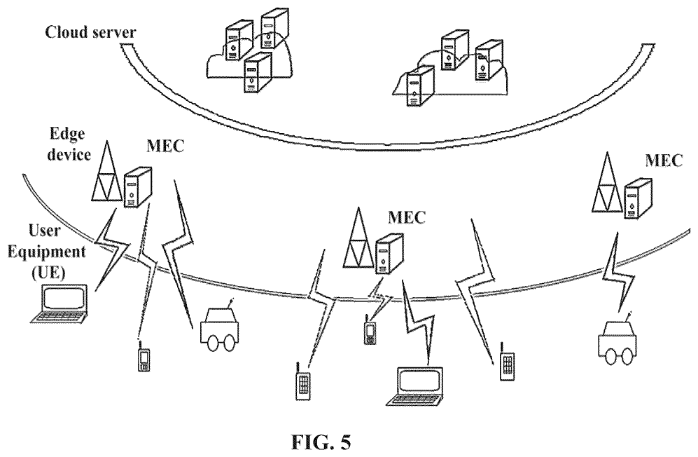

FIG. 4 is a flowchart of a computation offloading method according to embodiment three of the present disclosure. Applied to the second node, this embodiment uses an example where the first node is an edge device, and the second node is user equipment (UE) to further illustrate the computation offloading method. FIG. 5 is a diagram illustrating the system environment architecture of a computation offloading according to embodiment four of the present disclosure. As shown in FIG. 4, the method includes the steps described below.

After receiving the offloading requirement information sent by the user equipment, the edge device may identify whether the user equipment is a legal user.

The specific process of identity identification may include the steps described below.

In step 1, the edge device acquires bit information (encrypted information identifier) of a group [(UEID⊕MID_user)+Info_user] transmitted by the UE in advance. Since both the edge device and the cloud server store the encoding principle and the information bit length in advance, the edge device may disassemble the encrypted information identifier into (UEID⊕MID_user) (first encrypted information identifier) and Info_user (second encrypted information identifier).

UEID is a group of user IDs stored in the cloud server by the user equipment. Info_user is the information that the edge computing user corresponds to a group of users in the cloud server according to the UEID. MID_user is the user's International Mobile Equipment Identity.

In step 2, the edge device uploads (UEID⊕MID_user) (first encrypted information identifier) with an encryption key to the cloud server.

In step 3, the cloud server finds Info_user (fourth encrypted information identifier) according to the information in (UEID⊕MID_user).

In step 4, the edge device may receive (Group_ID⊕Info_user) (third encrypted information identifier) sent back by the cloud server with the encryption key. Group_ID is the ID of the edge device. The edge device may acquire the third encrypted information identifier according to Group_ID.

In step 5, the edge device disassembles the third encrypted information identifier into Group_ID (edge device group identifier) and Info_user (fourth encrypted information identifier) according to the encoding principle and the information bit length.

In step 6, Info_user (fourth encrypted information identifier) returned from the cloud server is compared with Info_user (second encrypted information identifier) transmitted by the UE to determine whether the two are consistent. If the two are consistent, it is considered that the user equipment is a legal node, that is, a legal user.

After the identity of the user equipment is determined as a legal user, the product of the remaining utilization rate of the central processing unit and the total computational capacity is used as the current remaining computational capacity (MB/s); the uplink transmission rate at which the user equipment uploads the offloading requirement information is extracted, the product of the reciprocal of the uplink transmission rate and the amount of data to be calculated in the offloading requirement information is used as the data transmission time, the ratio of the amount of data to be calculated to the current remaining computational capacity is used as the data operation time, and the sum of the data transmission time and the data operation time is used as the maximum delay time; the received signal strength of the offloading requirement information uploaded by the user equipment is extracted as the wireless communication quality information; meanwhile, the remaining computational capacity requirement is sent to another edge device to acquire the current remaining computational capacity of another edge device.

Preset conditions such as the maximum allowable delay time and the preset received signal strength threshold in the computational capacity requirement and offloading requirement information may be extracted. When the current remaining computational capacity is greater than or equal to the computational capacity requirement, it may be determined that the current remaining computational capacity satisfies the offloading requirement. When the maximum delay time is less than or equal to the maximum allowable delay time, it is determined that the maximum delay time satisfies the maximum allowable delay time. When the wireless communication quality information is greater than or equal to the preset received signal strength threshold, it may be determined that the wireless communication quality information satisfies the wireless communication quality requirement.

When the current remaining computational capacity does not satisfy the offloading requirement or the maximum delay time does not satisfy the maximum allowable delay time, it is determined whether another edge device satisfying the offloading requirement exists within the threshold range. If another edge device satisfying the offloading requirement exists within the threshold range, offloading request information is sent to the another edge device, and offloading change information is sent to the user equipment. If another edge device satisfying the offloading requirement does not exist within the threshold range, offloading rejection information is fed back to the user equipment, and assistance for the user equipment in performing computation offloading is refused.

If the wireless communication quality information does not satisfy the communication quality requirement, the switching wireless channel information is sent to the user equipment so that the user equipment changes the wireless channel to send the offloading requirement information. When the wireless communication quality information of the changed wireless channel information does not satisfy the communication quality requirement, the offloading rejection information is fed back to the user equipment, and assistance for the user equipment in performing computation offloading is refused. When the wireless communication quality information of the changed wireless channel information satisfies the communication quality requirement, it is determined whether a requirement exists for the maximum delay time in the offloading requirement information.

If a requirement exists for the maximum delay time in the offloading requirement information, the encryption request information is sent to the user equipment so that the user equipment encrypts the operation information according to the encryption request information, and after the user equipment agrees to the operation information, the encrypted operation information is received to assist the operation. If a requirement doesn't exist for the maximum delay time in the offloading requirement information, the power of the user equipment in the offloading requirement information is extracted, and when the power of the user equipment is sufficient, it is determined that the user equipment satisfies a self-operation requirement, the offloading rejection information is fed back to the user equipment, and assistance for the user equipment in performing computation offloading is refused; when the power of the user equipment is insufficient, it is determined whether another edge device satisfying the offloading requirement exists within the threshold range. If another edge device satisfying the offloading requirement exists within the threshold range, offloading request information is sent to the another edge device, and offloading change information is sent to the user equipment. If another edge device satisfying the offloading requirement does not exist within the threshold range, offloading rejection information is fed back to the user equipment, and assistance for the user equipment in performing computation offloading is refused.

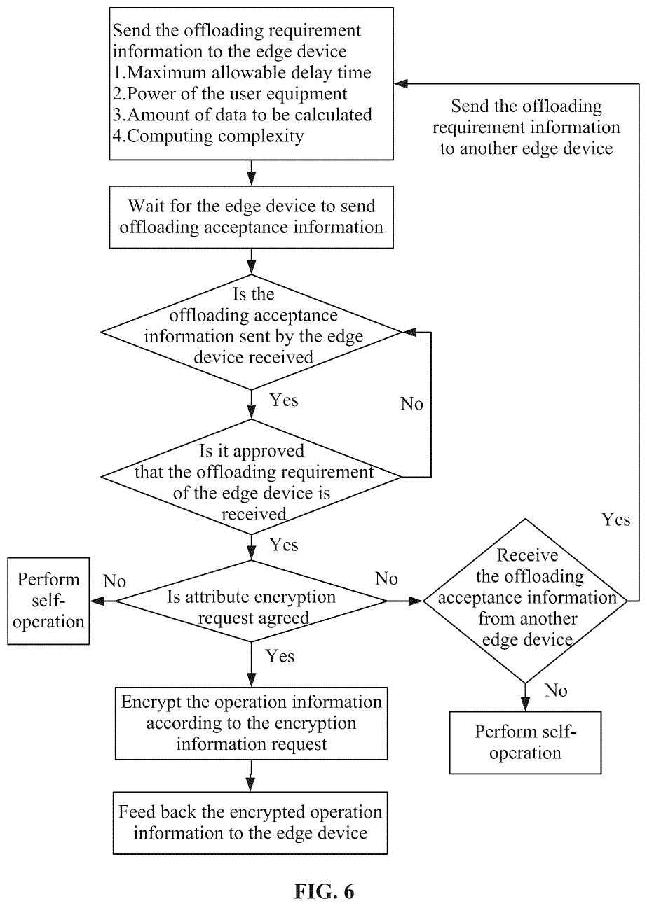

FIG. 6 is a flowchart of a computation offloading method according to embodiment four of the present disclosure, which is applied to user equipment. As shown in FIG. 6, the method includes the steps described below.

The user equipment sends offloading requirement information to the edge device. The offloading requirement information includes the maximum allowable delay time, the power of the user equipment, the amount of data to be calculated, and the computing complexity. The user equipment waits for the edge device to send the offloading acceptance information to determine whether to agree to accept the edge device's offloading requirement. If agreeing to accept the edge device's offloading requirement, the user equipment receives the encryption request information sent by the edge device. If the user equipment agrees to attribute encryption of the operation information, the user equipment encrypts the operation information according to the encryption request information and feeds the encrypted operation information back to the edge device. If the user equipment does not agree to attribute encryption of the operation information, the user equipment performs self-offloading according to the operation information. If the user equipment does not accept the offloading requirement from the edge device, the user equipment receives the offloading rejection information sent by the edge device and performs self-offloading according to the operation information or sends the offloading requirement information to another edge device.

### Embodiment Five

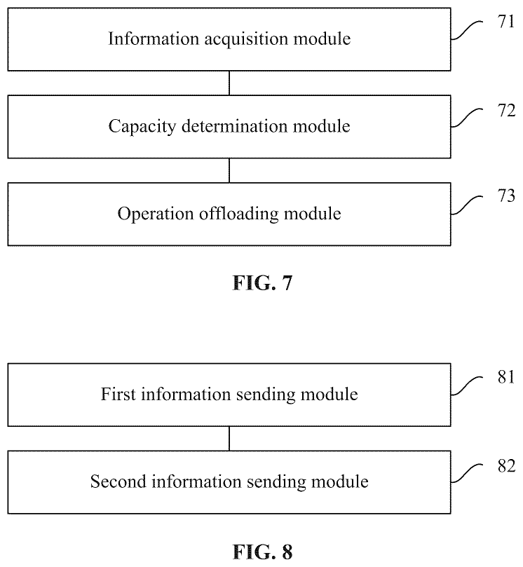

FIG. 7 is a diagram illustrating the structure of a computation offloading apparatus according to embodiment five of the present disclosure, which is applied to the first node. As shown in FIG. 7, the apparatus includes an information acquisition module 71, a capacity determination module 72, and an operation offloading module 73.

The information acquisition module 71 is configured to acquire offloading requirement information sent by a second node.

The capacity determination module 72 is configured to determine the current computational capacity according to the offloading requirement information.

The operation offloading module 73 is configured to send offloading acceptance information to the second node when the current computational capacity satisfies an offloading requirement so that the second node performs computation offloading.

According to the embodiments of the present disclosure, offloading requirement information sent by a second node is acquired via the information acquisition module, the capacity determination module determines the current computational capacity according to the offloading requirement information, and when the current computational capacity satisfies an offloading requirement, the operation offloading module sends offloading acceptance information to the second node so that the second node performs computation offloading. In this manner, when the computational capacity of the first node satisfies the offloading requirement, the first node can assist the second node in performing computation offloading, and when the second node cannot complete the operation on its own and requests the cloud server to assist in the operation, the computing pressure on the cloud server is reduced. Meanwhile, the security risks of the second node transmitting data to the cloud server are reduced, the security of data transmission in the process of computation offloading is improved, and user experience is enhanced.

In an embodiment, the computation offloading apparatus also includes an another node acquisition module, an assistance change module, and an assistance rejection module.

The another node acquisition module is configured to determine whether another first node satisfying the offloading requirement exists within the threshold range when the current computational capacity does not satisfy the offloading requirement.

The assistance change module is configured to: if the another first node exists, forward the offloading request information of the second node to the another first node and send offloading change information to the second node so that the another first node assists the second node in performing computation offloading.

The assistance rejection module is configured to: if the another first node does not exist, feed back offloading rejection information to the second node and refuse to assist the second node in performing computation offloading.

In an embodiment, the computation offloading apparatus also includes an encrypted identifier acquisition module, a user information search module, and a legal node determination module.

The encrypted identifier acquisition module is configured to receive an encrypted information identifier sent by the second node. The encrypted information identifier includes a first encrypted information identifier and a second encrypted information identifier. The first encrypted information identifier is determined by the XOR operation of the identity document of the second node and the International Mobile Equipment Identity of the second node. The second encrypted information identifier is the user information corresponding to the identity document of the second node.

The user information search module is configured to send the first encrypted information identifier to a cloud server and receive a third encrypted information identifier fed back by the cloud server. The third encrypted information identifier includes a first node group identifier and a fourth encrypted information identifier corresponding to the second encrypted information identifier. The fourth encrypted identifier information is the user information queried by the cloud server according to the first encrypted information.

The legal node determination module is configured to determine that the identity of the second node is a legal node when the second encrypted information identifier is identical to the fourth encrypted information identifier.

In an embodiment, the capacity determination module 72 includes a parameter determination unit, a first computational capacity determination unit, and a second computational capacity determination unit.

The parameter determination unit is configured to determine the current remaining computational capacity, maximum delay time, and wireless communication quality information according to the offloading requirement.

The first computational capacity determination unit is configured to determine that the current computational capacity satisfies the offloading requirement when it is determined that the current remaining computational capacity, the maximum delay time, and the wireless communication quality information all satisfy a preset condition.

The second computational capacity determination unit is configured to determine that the current computational capacity does not satisfy the offloading requirement when any one of the current remaining computational capacity, the maximum delay time, or the wireless communication quality information does not satisfy a preset condition.

In an embodiment, the parameter determination unit is specifically configured to perform the following: using the product of the remaining utilization rate of the central processing unit and the total computational capacity as the current remaining computational capacity; extracting the uplink transmission rate at which the second node uploads the offloading requirement information, and using the product of the reciprocal of the uplink transmission rate and an amount of data to be calculated in the offloading requirement information as data transmission time; using the ratio of the amount of data to be calculated to the current remaining computational capacity as data operation time; using the sum of the data transmission time and the data operation time as the maximum delay time; and extracting received signal strength of the offloading requirement information uploaded by the second node as the wireless communication quality information.

In an embodiment, the preset condition in the capacity determination module 72 includes at least one of the following: a computational capacity requirement, the maximum allowable delay time in the offloading requirement information, or a preset received signal strength threshold.

The computational capacity requirement is determined according to the amount of data to be calculated and the computing complexity in the offloading requirement information.

In an embodiment, the operation offloading module 73 includes an acceptance information sending unit and an operation offloading unit.

The acceptance information sending unit is configured to send the offloading acceptance information to the second node.

The operation offloading unit is configured to receive operation information fed back by the second node and assist the second node in performing data operation according to the operation information.

In an embodiment, the computation offloading apparatus also includes an encryption request module.

The encryption request module is configured to send encryption request information to the second node so that the second node encrypts operation information according to the encryption request information.

In an embodiment, the computation offloading apparatus also includes a channel switching module.

The channel switching module is configured to send switching wireless channel information to the second node so that the second node switches a wireless channel to send the offloading requirement information.

In an embodiment, the computation offloading apparatus also includes a requirement determination module, a first requirement running module, a second requirement running module, an offloading rejection module, and an information change module.

The requirement determination module is configured to determine whether a requirement for the maximum delay time exists in the offloading requirement information.

The first requirement running module is configured to acquire the operation information sent by the second node for offloading if the requirement for the maximum delay time exists in the offloading requirement information.

The second requirement running module is configured to extract the power of the second node in the offloading requirement information if the requirement for the maximum delay time does not exist in the offloading requirement information.

The offloading rejection module is configured to: when the power of the second node is sufficient, determine that the second node satisfies a self-operation requirement, feed back offloading rejection information to the second node, and refuse to assist the second node in performing computation offloading.

The information change module is configured to: when the power of the second node is insufficient, determine that the second node does not satisfy the self-operation requirement, send the offloading request information to another first node whose current computational capacity satisfies the offloading requirement, and send offloading change information to the second node so that the another first node assists the second node in the offloading.

The computation offloading apparatus provided by embodiments of the present disclosure may execute the computation offloading method according to any embodiment of the present disclosure and has corresponding functional modules and beneficial effects of executing the method.

### Embodiment Six

FIG. 8 is a diagram illustrating the structure of a computation offloading apparatus according to embodiment six of the present disclosure. As shown in FIG. 8, the apparatus includes a first information sending module 81 and a second information sending module 82.

The first information sending module 81 is configured to send offloading requirement information to a first node.

The second information sending module 82 is configured to receive offloading acceptance information sent by the first node, and when it is approved that the first node assists in offloading, send operation information to the first node.

In an embodiment of the present disclosure, the first information sending module sends the offloading requirement information to the first node, and the second information sending module receives the offloading acceptance information sent by the first node; when it is approved that the first node assists in offloading, the operation information is sent to the first node. In this manner, the requirement information of the first node is sent to the first node to ensure that the first node can assist in offloading according to the information sent by the second node.

In an embodiment, the computation offloading apparatus also includes a rejection feedback module.

The rejection feedback module is configured to: when it is disapproved that the first node assists in the offloading, feed back rejection information to the first node and send the offloading requirement information to another first node or perform self-offloading.

In an embodiment, the computation offloading apparatus also includes an encrypted identifier sending module.

The encrypted identifier sending module is configured to send an encrypted information identifier to the first node so that the first node verifies the identity according to the encrypted information identifier.

In an embodiment, the computation offloading apparatus also includes an attribute encryption determination module, an attribute encryption approval module, and an attribute encryption negation module.

The attribute encryption determination module is configured to determine whether to approve attribute encryption of the operation information when encryption request information fed back by the first node is received.

The attribute encryption approval module is configured to: if the attribute encryption of the operation information is approved, encrypt the operation information according to the encryption request information and feed back encrypted operation information to the first node.

The attribute encryption negation module is configured to perform self-offloading according to the operation information if the attribute encryption of the operation information is disapproved.

The computation offloading apparatus provided by embodiments of the present disclosure may execute the computation offloading method according to any embodiment of the present disclosure and has corresponding functional modules and beneficial effects of executing the method.

### Embodiment Seven

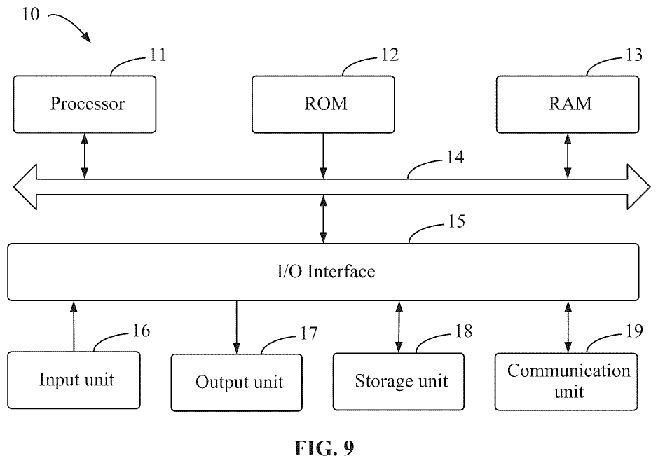

FIG. 9 is a diagram illustrating the structure of an electronic device 10 implementing a computation offloading method according to an embodiment of the present disclosure. The electronic device is intended to represent various forms of digital computers, for example, a laptop computer, a desktop computer, a worktable, a personal digital assistant, a server, a blade server, a mainframe computer, or other applicable computers. The electronic device may also represent various forms of mobile apparatuses such as a personal digital processing apparatus, a cellular phone, a smart phone, a wearable device (for example, a helmet, glasses, a watch), and other similar computing apparatuses. The components shown herein, their connections and relationships, and their functions, are by way of examples only and are not intended to limit implementations of the present disclosure described and/or claimed herein.

As shown in FIG. 9, the electronic device 10 includes at least one processor 11 and a memory in a communication connection with the at least one processor 11, such as a read-only memory (ROM) 12 and a random-access memory (RAM) 13. The memory stores a computer program executable by the at least one processor. The processor 11 may perform various appropriate actions and processes according to computer programs stored in a read-only memory (ROM) 12 or loaded from a storage unit 18 into a random-access memory (RAM) 13. The RAM 13 may also store various programs and data required for the operation of the electronic device 10. The processor 11, the ROM 12, and the RAM 13 are connected to each other through a bus 14. An input/output (I/O) interface 15 is also connected to the bus 14.

Multiple components in the electronic device 10 are connected to the I/O interface 15, including an input unit 16, such as a keyboard or a mouse; an output unit 17, such as various types of displays or speakers; a storage unit 18, such as a magnetic disk or an optical disk; and a communication unit 19, such as a network card, a modem, or a wireless communication transceiver. The communication unit 19 allows the electronic device 10 to exchange information/data with other devices through a computer network such as the Internet and/or various telecommunication networks.

The processor 11 may be various general-purpose and/or special-purpose processing components having processing and computing capabilities. Some examples of the processor 11 include, but are not limited to, a central processing unit (CPU), a graphics processing unit (GPU), various dedicated artificial intelligence (AI) computing chips, various processors running machine learning model algorithms, a digital signal processor (DSP), and any suitable processors, controllers, and microcontrollers. The processor 11 performs various methods and processes described above, such as a computation offloading method.

In some embodiments, the computation offloading method may be implemented as a computer program tangibly embodied in a computer-readable storage medium such as the storage unit 18. In some embodiments, part or all of the computer program may be loaded and/or installed on the electronic device 10 via the ROM 12 and/or the communication unit 19. When the computer program is loaded into the RAM 13 and executed by the processor 11, one or more steps of the computation offloading method described above may be performed. Optionally, in other embodiments, the processor 11 may be configured to perform the computation offloading method by any other suitable means (for example, by means of firmware).

Various implementations of the systems and techniques described above herein may be implemented in digital electronic circuitry, integrated circuitry, a field programmable gate array (FPGA), an application specific integrated circuit (ASIC), an application specific standard product (ASSP), a system on chip (SOC), a complex programmable logic device (CPLD), computer hardware, firmware, software, and/or combinations thereof. The various implementations may include an implementation in one or more computer programs that may be executable and/or interpretable on a programmable system including at least one programmable processor. The programmable processor may be special-purpose or general-purpose for receiving data and instructions from a memory system, at least one input apparatus, and at least one output apparatus and transmitting the data and instructions to the memory system, the at least one input apparatus, and the at least one output apparatus.

The computer program for implementing the method of the present disclosure may be written in any combination of one or more programming languages. These computer programs may be provided to a processor of a general-purpose computer, special-purpose computer, or other programmable data processing apparatus such that the computer programs, when executed by the processor, cause the functions/operations specified in flowcharts and/or block diagrams to be implemented. The computer program may be executed entirely or partly on the machine, as a stand-alone software package partly on the machine and partly on a remote machine, or entirely on the remote machine or server.

In the context of the present disclosure, a computer-readable storage medium may be a tangible medium that may contain or store a computer program for use by or in conjunction with an instruction execution system, apparatus, or device. The computer-readable storage medium may include, but is not limited to, electronic, magnetic, optical, electromagnetic, infrared, or semiconductor systems, apparatuses, or devices, or any suitable combination thereof. Optionally, the computer-readable storage medium may be a machine-readable signal medium. Examples of the machine-readable storage medium may include an electrical connection based on one or more wires, a portable computer disk, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

To provide interaction with a user, the systems and techniques described herein may be implemented on an electronic device. The electronic device has a display device (for example, a CRT (cathode ray tube) or LCD (liquid crystal display) monitor) for displaying information to the user; and a keyboard and pointing apparatus (for example, a mouse or a trackball) through which a user can provide input to the electronic device. Other types of apparatuses may also be used for providing interaction with a user. For example, feedback provided to the user may be sensory feedback in any form (for example, visual feedback, auditory feedback, or haptic feedback). Moreover, input from the user may be received in any form (including acoustic input, voice input, or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein), or a computing system including any combination of such back-end, middleware, or front-end components. Components of a system may be interconnected by any form or medium of digital data communication (for example, a communication network). Examples of the communication network include a local area network (LAN), a wide area network (WAN), a blockchain network, and the Internet.

The computing system may include a client and a server. A client and a server are generally remote from each other and typically interact through a communication network. The relationship between the client and the server is established by computer programs running on the respective computers, having a client-server relationship with each other. The server, which may be a cloud server and is also referred to as a cloud computing server or a cloud host, is a host product in a cloud computing service system. The server solves the problems of difficult management and weak service scalability in the service of a related physical host and a related VPS.

It is to be understood that various forms of processes shown above may be adopted with steps reordered, added, or deleted. For example, the steps described in the present disclosure may be performed in parallel, sequentially, or in different orders, as long as the desired results of the technical solutions of the present disclosure can be achieved, and no limitation is imposed herein. The preceding embodiments do not limit the scope of the present invention. It is to be understood by those skilled in the art that various modifications, combinations, sub-combinations, and substitutions may be performed according to design requirements and other factors.

What is claimed is:

1. A computation offloading method, being applied to a first node and comprising:
acquiring offloading requirement information sent by a second node;
determining current computational capacity of the first node according to the offloading requirement information; and
based on a determining result that the current computational capacity of the first node satisfies an offloading requirement, sending offloading acceptance information to the second node so that the second node performs computation offloading.

2. The method of claim 1, further comprising:
based on a determining result that the current computational capacity of the first node does not satisfy the offloading requirement, determining whether another first node satisfying the offloading requirement exists within a threshold range;
based on a determining result that the another first node satisfying the offloading requirement exists within the threshold range, forwarding offloading request information of the second node to the another first node, and sending offloading change information to the second node so that the another first node assists the second node in performing computation offloading; or
based on a determining result that the another first node satisfying the offloading requirement does not exist within the threshold range, feeding back offloading rejection information to the second node, and refusing to assist the second node in performing computation offloading.

3. The method of claim 1, wherein before determining the current computational capacity of the first node according to the offloading requirement information, the method further comprises:
receiving an encrypted information identifier sent by the second node; wherein the encrypted information identifier comprises a first encrypted information identifier and a second encrypted information identifier, the first encrypted information identifier is determined by XOR operation of an identity document of the second node and an International Mobile Equipment Identity of the second node, and the second encrypted information identifier is user information corresponding to the identity document of the second node;
sending the first encrypted information identifier to a cloud server, and receiving a third encrypted information identifier fed back by the cloud server; wherein the third encrypted information identifier comprises a first node group identifier and a fourth encrypted information identifier corresponding to the second encrypted information identifier, and the fourth encrypted information identifier is user information queried by the cloud server according to first encrypted information; and
based on a determining result that the second encrypted information identifier is identical to the fourth encrypted information identifier, determining that an identity of the second node is a legal node.

4. The method of claim 1, wherein determining the current computational capacity of the first node according to the offloading requirement information comprises:
determining current remaining computational capacity, maximum delay time, and wireless communication quality information according to the offloading requirement;
determining that the current computational capacity of the first node satisfies the offloading requirement based on a determining result that the current remaining computational capacity, the maximum delay time, and the wireless communication quality information all satisfy a preset condition; or
determining that the current computational capacity does not satisfy the offloading requirement based on a determining result that any one of the current remaining computational capacity, the maximum delay time, or the wireless communication quality information does not satisfy a preset condition.

5. The method of claim 4, wherein determining the current remaining computational capacity, the maximum delay time, and the wireless communication quality information according to the offloading requirement comprises:
using a product of a remaining utilization rate of a central processing unit and total computational capacity as the current remaining computational capacity;
extracting an uplink transmission rate at which the second node uploads the offloading requirement information, and using a product of a reciprocal of the uplink transmission rate and an amount of data to be calculated in the offloading requirement information as data transmission time;
using a ratio of the amount of data to be calculated to the current remaining computational capacity as data operation time;
using a sum of the data transmission time and the data operation time as the maximum delay time; and
extracting received signal strength of the offloading requirement information uploaded by the second node as the wireless communication quality information.

6. The method of claim 4, wherein the preset condition comprises at least one of a computational capacity requirement, maximum allowable delay time in the offloading requirement information, or a preset received signal strength threshold;
wherein the computational capacity requirement is determined according to an amount of data to be calculated and computing complexity in the offloading requirement information.

7. The method of claim 1, wherein based on the determining result that the current computational capacity of the first node satisfies the offloading requirement, sending the offloading acceptance information to the second node so that the second node performs computation offloading comprises:
sending the offloading acceptance information to the second node; and
receiving operation information fed back by the second node, and assisting the second node in performing data operation according to the operation information.

8. The method of claim 1, wherein after sending the offloading acceptance information to the second node, the method further comprises:
sending encryption request information to the second node so that the second node encrypts operation information according to the encryption request information.

9. The method of claim 4, wherein after determining that the wireless communication quality information does not satisfy the preset condition, the method further comprises:
sending switching wireless channel information to the second node so that the second node switches a wireless channel to send the offloading requirement information.

10. The method of claim 1, wherein after the current computational capacity of the first node satisfies the offloading requirement, the method further comprises:
determining whether a requirement for maximum delay time exists in the offloading requirement information;
based on a determining result that the requirement for the maximum delay time exists in the offloading requirement information, acquiring operation information sent by the second node for offloading; or
based on a determining result that the requirement for the maximum delay time does not exist in the offloading requirement information, extracting power of the second node in the offloading requirement information;
based on a determining result that the power of the second node is sufficient, determining that the second node satisfies a self-operation requirement, feeding back offloading rejection information to the second node, and refusing to assist the second node in performing computation offloading; or
based on a determining result that the power of the second node is insufficient, determining that the second node does not satisfy the self-operation requirement, sending offloading request information to another first node whose current computational capacity satisfies the offloading requirement, and sending offloading change information to the second node so that the another first node assists the second node in the offloading.

11. A computation offloading method, being applied to a second node and comprising:
sending offloading requirement information to a first node; and
receiving offloading acceptance information sent by the first node, and based on a determining result of approving that the first node assists in offloading, sending operation information to the first node.

12. The method of claim 11, further comprising:
based on a determining result of disapproving that the first node assists in the offloading, feeding back rejection information to the first node, and sending the offloading requirement information to another first node or performing self-offloading.

13. The method of claim 11, further comprising:
sending an encrypted information identifier to the first node so that the first node verifies an identity according to the encrypted information identifier.

14. The method of claim 11, further comprising:
when receiving encryption request information fed back by the first node, determining whether to approve attribute encryption of the operation information; and
based on a determining result of approving the attribute encryption of the operation information, encrypting the operation information according to the encryption request information, and feeding back encrypted operation information to the first node; or
based on a determining result of disapproving the attribute encryption of the operation information, performing self-offloading according to the operation information.

15. An electronic device, comprising:
at least one processor; and
a memory in communication with the at least one processor;
wherein the memory stores a computer program executable by the at least one processor, and the computer program is configured to be executed by the at least one processor to cause the at least one processor to execute the computation offloading method of claim 1.

16. A non-transitory computer-readable storage medium, configured to store computer instructions, the computer instructions are configured to be executed by a processor to cause the processor to implement the computation offloading method of claim 1.

17. An electronic device, comprising:
at least one processor; and
a memory in communication with the at least one processor;
wherein the memory stores a computer program executable by the at least one processor, and the computer program is configured to be executed by the at least one processor to cause the at least one processor to execute the computation offloading method of claim 11.

18. A non-transitory computer-readable storage medium, configured to store computer instructions, the computer instructions are configured to be executed by a processor to cause the processor to implement the computation offloading method of claim 11.
